(19) United States
(12) Patent Application Publication
(10) Pub. No.: US 2024/0321129 A1
(43) Pub. Date: Sep. 26, 2024

(54) Task Completion Path Generator for Instructional Content

(71) Applicant: Microsoft Technology Licensing, LLC, Redmond, WA (US)

(72) Inventors: Tomasz Lukasz Religa, Seattle, WA (US); Kartik Mathur, Bellevue, WA (US)

(21) Appl. No.: 18/123,885

(22) Filed: Mar. 20, 2023

(51) Int. Cl. G09B 5/02; G06F 3/0482

(52) U.S. Cl. CPC G09B 5/02; G06F 3/0482

(57) ABSTRACT

A computer implemented method includes accessing instructional content that describes a task for completion by a user. Actions described in the instructional content are derived from the instructional content. Telemetry containing logged actions taken by users is accessed and used to identify actions taken that are associated with the task. A machine learning model is used to identify a task completion path endpoint for the instructional content based on the derived actions and actions taken associated with the task.

### BACKGROUND

Tutorial or help articles may contain instructions describing how to complete tasks. Articles may describe a set of actions or steps that need to be taken or executed to complete one or more tasks. Tasks described for software applications may require making several selections, such as clicking on or navigating to various interface elements to accomplish a task.

Determining whether tutorials are accurate, effective, or helpful can involve asking users if a tutorial was helpful and then generating satisfaction scores. Users may not respond, or their response may be inaccurate. Such responses may not provide a clear insight into whether a user could successfully follow instructions in the tutorial. Some prior systems have utilized humans to manually identify toolbar command identifiers (TCIDs) described in the tutorials and then correlated actual user actions following user selection or viewing of a labeled tutorial to determine whether or not the user successfully performed the task described in the tutorial.

Manual labeling of tutorials with TCIDs can be inaccurate as well as extremely time consuming. There may be thousands of tutorials for one or more software applications. Software application user interfaces may also be frequently updated, requiring new tutorials for new tasks, or even revised tutorials, as the path of user actions required to accomplish revised tasks may be changed.

### SUMMARY

A computer implemented method includes accessing instructional content that describes a task for completion by a user, applying a named entity recognition natural language processing model to derive actions described in the instructional content, accessing telemetry data containing logged actions taken by users, processing the telemetry data to identify actions taken in the telemetry data associated with the task, identifying features from the instructional content, telemetry data, derived actions and actions taken, inputting the features to a machine learning model trained on training data that includes labeled instances of instructional content, telemetry data and features identified therefrom to select a task completion path endpoint label for the instructional content, monitoring user-initiated actions in response to access of the instructional content, generating an effectiveness measure for the instructional content as a function of the task completion path endpoint label and the monitored user-initiated actions to identify a portion of the instructional content for editing, and providing the effectiveness measure to an editor for editing the instructional content.

### BRIEF DESCRIPTION OF THE DRAWINGS

FIG. 1 is a block diagram illustrating example instructional content and corresponding actions according to an example embodiment.

FIG. 2 is a block diagram of a system for automated identification of endpoints from instructional content and identification of an action path for accomplishing a task according to an example embodiment.

FIG. 3 is a block flow diagram of a method for identifying paths for instructional content according to an example embodiment.

FIG. 4 is a flowchart illustrating a computer implemented method to automatically identify actions described in instructional content for use in evaluating the instructional content against actions taken by a user exposed to the instructional content according to an example embodiment.

FIG. 5 is a flowchart illustrating a computer implemented method for identifying actions taken from the telemetry data associated with the task according to an example embodiment.

FIG. 6 is a flowchart illustrating a computer implemented method of evaluating instructional content for accuracy and effectiveness according to an example embodiment.

FIG. 7 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Instructional content, such as help or tutorial articles, often contain sets of steps that need to be executed to complete the tasks described in them. Following these steps in software products typically requires users to press buttons, click menu items, and perform other actions so that the task described in an article is executed correctly. Each of these actions will typically result in a telemetry log that can be monitored to see if the task has been executed. The usefulness, clarity, effectiveness, and accuracy of the article can be evaluated by looking at the frequency of successful task completions following viewing of the article.

Most applications have a deep logging structure that can track individual user actions ranging from mouse clicks, scrolling and custom commands to create user action telemetry. Instructional content usually instructs a user to click on a series or sequence of Toolbar Commands (TCIDs). If the user is able to follow this sequence to an end action or endpoint, then the instructional content served its purpose. If all instructional content is labeled with an appropriate task completion path, the performance of the instructional content can be evaluated by comparing the task completion path with the user actions taken.

Assigning the task completion path labels to instructional content is a difficult manual process. There may be thousands of instructional content, such as help or tutorial articles. Each article would need to be reviewed and analyzed in its entirety by manually verifying what tasks were being referenced and discerning the instructions or actions needed to complete each task. Given the volume of new instruction content that has been and is being created and changed daily is not feasible. Automation of labeling articles is also technically difficult. While articles can be processed using natural language processing techniques, such processing does not produce reliable labels.

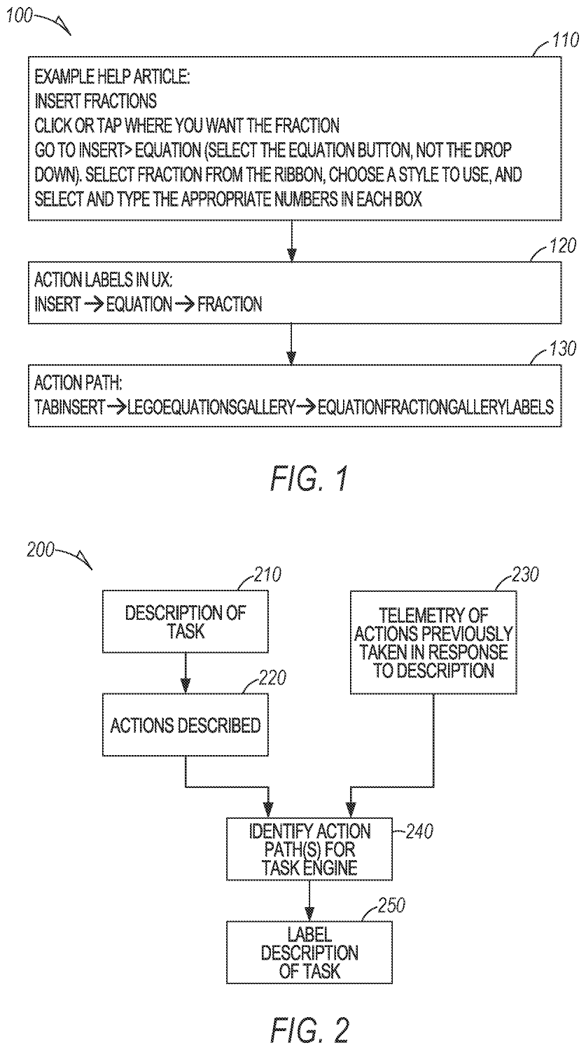

FIG. 1 is a block diagram illustrating example instructional content and corresponding actions generally at 100. An example help article 110 describes how to perform a task of “insert fractions.” The article may be accessed and displayed in response to a help request submitted by the user, by an intelligent assistant, or other means. Example help article 110 recites:
“Click or tap where you want the fraction.
Go to Insert>Equation (select the Equation button, not the drop Down). Select Fraction from the ribbon, choose a style to use, and select and type the appropriate numbers in each box.”

A user interface corresponding to the article 110 indicates names of the actions to be performed to accomplish the task. The names of the actions may be on buttons on a tool bar ribbon and include “Insert,” “Equation,” and “Fraction.” Clicking on buttons with those action labels should accomplish the task.

Each of those buttons are labeled with names that relate to a task, but buttons not related to the task may have similar names. For example, the name “Home” may be a name used on different buttons, such as on a File menu or on a toolbar. The correct buttons are identified at an action path 130 in which the correct buttons have unique names of “TabInsert”, “LegoEquationsGallery”, and “EquationFractionGalleryLabels.” Action path 130 is the correct task completion path, with “EquationFractionGalleryLabels” being a final endpoint of the task completion path for the example article 110. When a user selects the endpoint, the task described in the instructional content is considered completed or successful. In one example, the unique names are toolbar IDs (TCIDs).

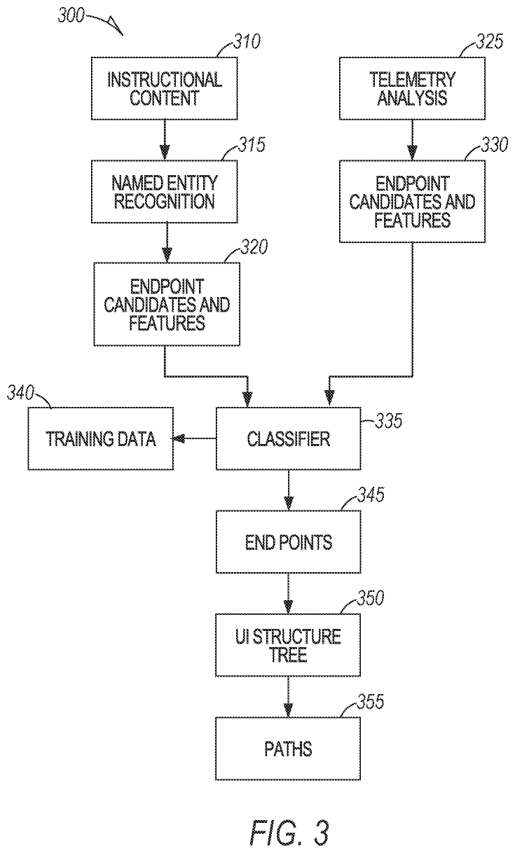

FIG. 2 is a block diagram of a system 200 for automated identification of endpoints from instructional content and identification of an action path for accomplishing a task. System 200 accesses description 210 of a task. The description 210 may be any type of instructional content that describes actions a user should take to accomplish the task. For software instructional content, such as help articles or tutorials, the actions may be user actions to interact with software generated user interfaces to accomplish the task, such as inserting fractions in an equation, inserting a watermark in a document, moving columns in a spreadsheet, formatting a disk, or any other task. As software includes many different applications, operating systems, and other software, each with multiple different functions, thousands of articles and tutorials may be generated.

To determine suitable paths for an article, the end goal of the article is first determined by system 200. The end goal of the article takes the form of a set of leaf nodes for the user to select to complete the task. For example, in an article with a title: “Check spelling and grammar with editor.” an editor ribbon opening a last leaf node, referred to as the endpoint, that signifies a successful task completion. Once the endpoint is identified, an action path of nodes or actions selected may be reconstructed by using a parent-child relationship of an existing user interface (UI) structure tree.

In one example, finding endpoints is performed using a supervised combination of two techniques that include a first technique of using of named entity recognition (NER) 220 on the description 210 to identify actions that are described in the description 210. A second technique utilizes telemetry analysis 230 of actions already taken by users in response to having viewed the description 210. Telemetry includes timestamps and TCIDs or other command IDs of actions taken by users following viewing of the description for a selected period of time. Both techniques identify respective potential endpoints.

The potential endpoints from both techniques are provided to an engine 240 that is trained to identify one or more action paths for the description 210. More than one action path may be identified where multiple tasks are described in a description 210.

Engine 240 may generate or receive multiple different features from the NER 220 and telemetry analysis 230 for each endpoint. Each feature is a measurable characteristic or property of a dataset that is used as input to a machine learning model. The features are described in further detail below and are represented as numerical or categorical values that describe the relevant aspects of the data that the model needs to learn from to make accurate predictions or decisions.

The endpoints and features may be processed by a machine learning model to determine a most likely endpoint. The machine learning model may be trained via supervised learning, where multiple descriptions have been labeled correctly.

Feature weights may be used to ensure optimization of a metric. In one example, the metric is a measure of how well the model does at predicting the right endpoint or action path. In one example, the metric is a traffic weighted measure of precision and recall. Optimization is performed on traffic weighted precision, P, and recall, R, to make sure the model provides the best possible output.

In instances where a certain endpoint is missing or misattributed, a penalty may be proportional to the resultant error in measuring an endpoint for that description. Missing a preferred endpoint or action path carries a higher penalty since the traffic for that endpoint is greater. Thus, a traffic weighted measure of precision and recall provides the best overview of the accuracy of the predicted task completion paths.

The engine 240 reconstructs the rest of the action path backwards from the most likely endpoint. The description 210 is then labeled at 250 with the action path. In various examples, thousands of descriptions may be labeled with identified task completion paths which are compared to actual paths taken by users following the user accessing the descriptions. Deviations from the identified task completion paths may be used to characterize the accuracy, effectiveness, and clarity of descriptions.

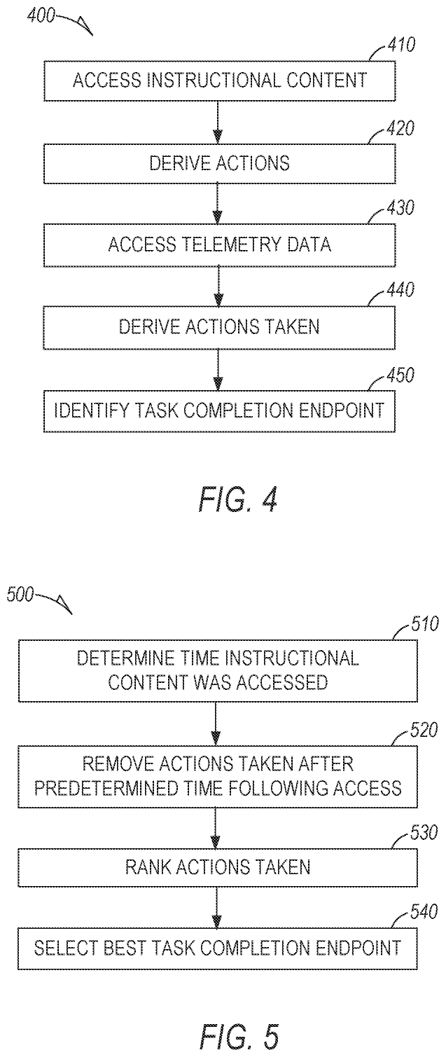

FIG. 3 is a block flow diagram of a method 300 for identifying paths for instructional content 310. Instructional content 310 may be help articles or tutorials for software applications or information the describes actions to be taken by a person. The instructional content 310 is provided to a named entity recognition operation 315 that identifies endpoint candidates and features 320.

Isolating instructions in a body of text can be challenging in situations where the text is verbose or includes alternative paths. By using a well-defined user telemetry system, it is possible to increase accuracy significantly. User behavior can become a guide to understanding not just support articles, but any text-based asset. The use of telemetry to increase accuracy is telemetry independent and can be transferred across different systems and products.

A telemetry analysis operation 325 identifies endpoint candidates and features 330 from telemetry data that includes actions taken by users in performing many different tasks.

When users navigate to a specific article, they are more likely to interact with TCIDs that are relevant to that article. For example, in the article ‘Insert a Watermark’ the user is more likely to click ‘Watermark’ than ‘Editor.’ User telemetry can guide predictions and filter for TCIDs that are leaf nodes for that article. The frequency distribution of TCIDs (Toolbar Command Identifiers) is unique to different support articles.

Users who visit the ‘Insert a Watermark” (1) article are likely to interact with the Word app very differently from users that visit an ‘Insert a Table’ (2) article. The telemetry data includes information representative of different user actions corresponding to each article. The ‘Watermark’ button has been clicked a lot more in (1) than in (2). Expanding on that reasoning, one can see that the ‘Home’ button on the app that is more general purpose and is clicked a lot regardless of the article that was just viewed. By analyzing the distribution, an estimate can be made as to what TCIDs would be suitable endpoints (‘Watermark’), and which TCIDs would qualify as Nodes and not Endpoints (‘Home’).

Features that represent a measurable property of the telemetry data may include frequency distributions of TCIDs selected after a user views the article. The overall frequency of TCID selections may also be a feature that is representative of the sum of article frequency. Other features are described in further detail below, including features derived from the instructional content.

The combination of using both named entity recognition on the content along with telemetry analysis provides an enhanced automated labeling of the content. Telemetry alone is biased towards a particular path. If users ignore a particular node (action), then this approach might miss one of the candidates. Content such as articles also contain many different instructions sets, so they often reference TCIDs that are not relevant to the current user journey. The following example article references two different tasks—how to create a booklet or book along with print settings for booklets.
“Create a booklet or book
1. Go to Layout and select Page Setup dialog launch icon at the bottom-right corner.
2. One the Margins tab, change the setting for Multiple pages to Book fold. The orientation automatically changes to Landscape. Set Sheets per booklet to break up a large document into smaller booklets that can be bound together.
3. Adjust the Gutter setting to reserve space on the inside fold for binding.
4. Choose a Paper size on the Paper tab. The final size of the booklet is half width of the paper size.
5. Click OK. The document automatically formats, but you might need to adjust objects like images and tables manually.
Print settings for booklets
1. Got to File>Print.
2. Change Print One Sided to Print on Both Sides. Choose Flip pages on short edge.
3. If your printer doesn't support automatic printing on both sides, select Manually Print on Both Sides, and feed the pages back to the printer when prompted.”

Although they are helpful to know, the print settings are not representative of the task the user has started on i.e., Creating a booklet. Thus, not all TCIDs that are referenced in the article are good candidates for task completion. To resolve this, a binary classification may be applied to each leaf candidate to determine if they should be included in the prediction.

Through this relationship, TCIDs that are highly relevant to the article can be ranked to facilitate narrowing of a pool of endpoint candidates. A T-test on two populations of multiple TCIDs may be used to narrow the pool by selecting the highest ranked TCIDs:
P (TCID1 . . . n) and P (TCID1 . . . n|Article=X)

To perform the test, user clickstream information from telemetry is accessed. The clickstream information includes the TCID interacted with along with the timestamp and client metadata in rows. Each row corresponds to a unique user interaction. The clickstream data may include further information, including the name or other identifier of an application or program associated with each TCID if not inherent in the TCID.

The data may be cleaned for empty values. Interactions may be limited to within one minute of opening corresponding instructional content like a help article to ensure that the most relevant TCIDs are used. The one-minute time limit may be derived from user engagement analysis that suggests that users stick to a task for up to a minute on average. The time limit may be varied in further examples and possibly based on the complexity of the corresponding task.

To account for as many user interface (UI) changes as possible, the user interactions may span a yearlong or longer timeframe for multiple different applications or other software. Shorter timeframes may be used in further examples.

Two different sets of endpoint candidates and sets of features are provided to a classifier 335 that has been trained on training data 340. The sets of endpoint candidates include content based endpoint candidates from endpoint candidates and features 320 and telemetry based candidate endpoints from candidate endpoint and features 330. The training data may include true completion task paths that may be hand labeled, or just endpoints identifying completion of a task correlated with each article of multiple articles.

The training data may also include the features derived from named entity recognition operation 315 and telemetry analysis operation 325 corresponding to the multiple articles. Classifier 335 is trained on such training data to select a final leaf node, referred to as the endpoint. In one example, the classifier 335 is Random Forest classifier model which takes as input multiple of the following features in addition to a candidate endpoint identified by a TCID:
IsNER: Was the TCID referenced in the article body?
IsTelemetry: Is the TCID ranked in the top 3 most relevant TCIDs?
IsLabel (y): A text based label.
TelemetryRank: Rank of TCID based on telemetry.
NEROrder: Order in which TCID is referenced in the article body.
NERFreq: Number of times TCID is referenced in the article body.
BaseFreq: The base frequency is the occurrence of a particular TCID across every article.
CountOfTCIDGivenArticle: Number of times TCID as used upon viewing a specific article.
PValue: p-value of TCID for a specific article. Low is a false positive-statistical test.

The classifier 335 model success is predicated on assigning task completion paths that help gauge the success of the instructional content 310. In instances where a certain candidate endpoint is missing or misattributed, a penalty during training must be proportional to the resultant error in measuring task completion for that instructional content 310. Missing a preferred user path should carry a higher penalty since the traffic for that endpoint is greater. Thus, a traffic weighted measure of precision and recall provides the best overview of the accuracy of the predicted TC paths or endpoints 345.

Given the endpoint 345, a user interface structure 350 that describes all paths that may be followed in a user interface may be used to backtrack from an endpoint to generate the task completion path 355.

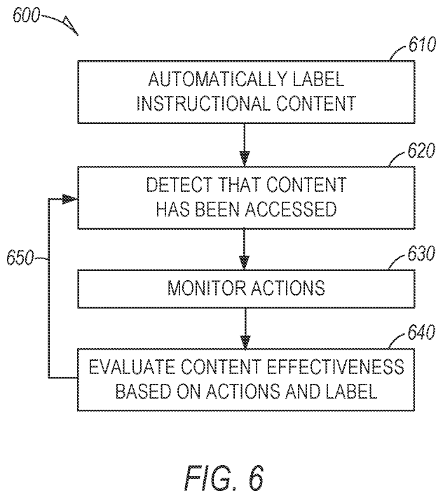

FIG. 4 is a flowchart illustrating a computer implemented method 400 to automatically identify actions described in instructional content for use in evaluating the instructional content against actions taken by a user exposed to the instructional content. Method 400 begins at operation 410 by accessing instructional content that describes a task for completion by a user. In one example, the instructional content is a help article or tutorial that describes how to accomplish a task via a user interface that may include one or more user interface elements such as buttons or toolbars. Each user interface element may have a unique toolbar command ID, referred to as a TCID.

Actions are derived from the instructional content at operation 420. Deriving actions from instructional content may be performed using named entity recognition information extraction software in one example.

Operation 430 accesses telemetry data containing previously logged actions taken by prior users. Actions taken by prior users are identified at operation 440 from the telemetry data associated with the task. Operation 450 uses a machine learning model to identify a task completion path endpoint for the instructional content based on the derived actions and actions taken associated with the task. The task completion path may include a sequence of TCIDs.

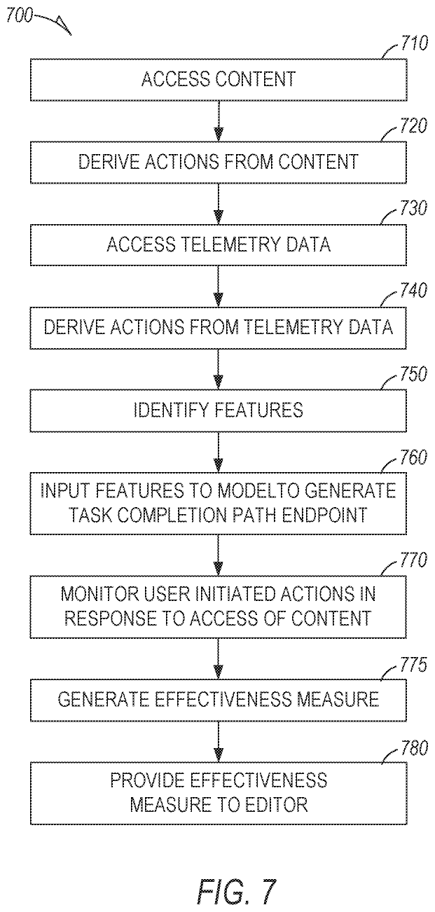

FIG. 5 is a flowchart illustrating a computer implemented method 500 for identifying actions taken from the telemetry data associated with the task. Method 500 beings at operation 510 by determining a time that the instructional content was accessed. Operation 520 removes actions taken after a predetermined time following access of the instructional content. The predetermined time is one minute or less in one example or longer in further examples. Actions taken are ranked at operation 530 based on relevance to the instructional content to identify action taken endpoint candidates.

The actions described in the instructional content comprise instructional content endpoint candidates. At operation 540, the action taken endpoint candidates and instructional content endpoint candidates are processed via the machine learning model comprising a Random Forest classifier model to select the best task completion path endpoint.

In one example, the Random Forest classifier model is trained on labeled data derived from the instructional content and telemetry data based on the action taken endpoint action candidates and instructional content endpoint action candidates. The training data and input data may include multiple elements selected from the group consisting of an indication identifying whether the endpoint is referenced in the instructional content, whether the endpoint is ranked in the top three most relevant candidate endpoints, whether the task endpoint is a text label, a rank of the endpoint based on the telemetry, the order in which the endpoint is referenced in the instructional content, a number of times the endpoint is referenced in the instructional content, a base frequency of the final endpoint across multiple articles, the number of times an endpoint is used upon viewing the instructional content, or a p-value for the final endpoint for the instructional content.

At operation 550, a user interface tree is used to identify a task completion path from the final endpoint. The user interface tree is a visualization of a hierarchy of functions that may be selected. In a word processing program, for example, selection of “insert” from a toolbar may provide several options, such pages, tables, pictures, shapes, links, comments, etc. One or more options may reveal further options when selected, such as cover page, blank page, or page break in response to selection of page. The user interface tree simply shows all such options in a tree form.

In one example operation 550 starts at the final endpoint and traces back up the tree from the final endpoint, adding each action encountered in the tree to form the task completion path.

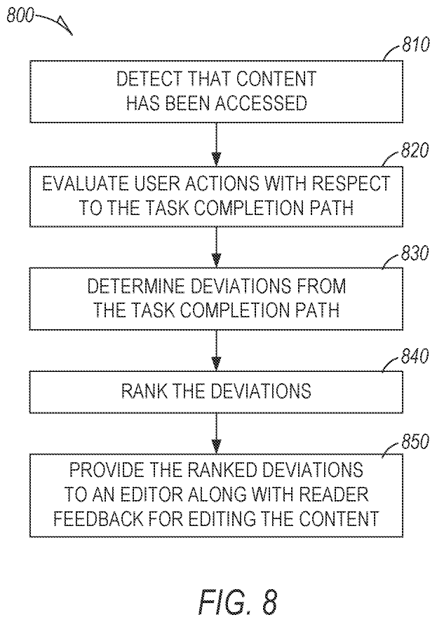

FIG. 6 is a flowchart illustrating a computer implemented method 60W of evaluating instructional content for accuracy and effectiveness. Method 600 beings at operation 610 by labeling the instructional content with the task completion path. Operation 620 detects that the instructional content has been accessed for a user. User-initiated actions are monitored at operation 630 in response to access of the instructional content. The user-initiated actions are evaluated at operation 640 with respect to the task completion path to determine an effectiveness of the instructional content.

Operation 640 determines whether the task has been completed by comparing the TCIDs identified from the monitored user-actions with the task completion path label for the instructional content. If the TCID endpoint of the task completion path has been detected within a predetermined time after the user has viewed the instructional content, the task has been completed successfully. In one example if a selected percentage of users reached the TCID endpoint of the task completion path, referred to as an instructional content effectiveness threshold, that instructional content is identified as effective. Such percentage may be selected to be between 90 and 100% in one example, but may be varied depending on the importance of the task to users as identified from user feedback.

If the task has not been completed successfully, the point at which user actions deviated from the task completion path may be determined with statistics generated to show percentages of users that reached different points of the task completion path, referred to as drop-off points. Such percentages may be thought of as scores and may be prioritized. For example if the highest percentage of users never found the first TCID, that feedback can be provided to an editor of the instructional content, who then knows to investigate how the instructional content can be modified.

In another example, users may have mostly made it to a second TCID in the task completion path and then deviated from the path. The editor may note this deviation and may even look to see what TCIDs or other action was performed following the second TCID. This information can help in editing instructional content to more clearly describe the next action to take, or not to take.

In one example, an editing process for the instructional content may include receiving user feedback over a period of time and then determining actionable items based on the user feedback in accordance with prior editing processes. Through the use of the task completion path, the editor may identify the most likely drop-off points from the path based on prioritized scores. Such drop off points can help the editor identify specific points of the instructional content that may need revising, such as text occurring just after text describing the last successfully found point or node in the task completion path.

Revisions may be made, with new information collected with each revision, resulting in an iterative process as indicated at 650 to continue to improve the effectiveness and clarity of the instructional content.

Assigning labels to instructional content in an automated manner enables article effectiveness calculations in real time while users are attempting to perform described tasks. Detailed data regarding user deviation from the task completion path provides a salient measure of the effectiveness in both detail and at scale. The data can be analyzed to identify exact user actions that deviate from the sequence of actions in the task completion path, allowing content authors to revise the instructional content to enhance content effectiveness.

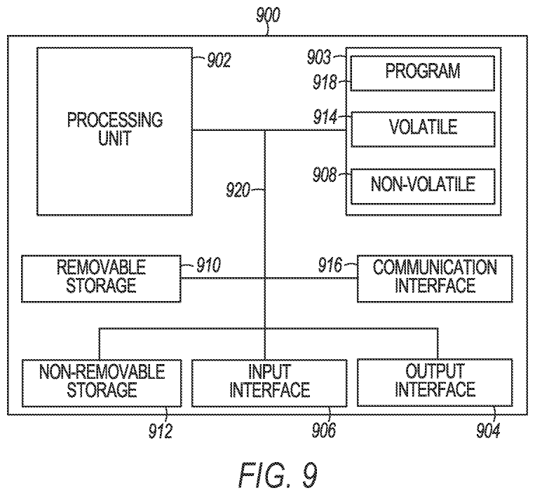

FIG. 7 is a flowchart illustrating a computer implemented method 700 to automatically identify actions described in instructional content for use in evaluating the instructional content against actions taken by a user exposed to the instructional content. Method 700 begins at operation 710 by accessing instructional content that describes a task for completion by a user. In one example, the instructional content is a help article or tutorial that describes how to accomplish a task via a user interface that may include one or more user interface elements such as buttons or toolbars. Each user interface element may have a unique toolbar command ID, referred to as a TCID.

Actions are derived from the instructional content at operation 720. Deriving actions from instructional content may be performed using named entity recognition information extraction software in one example.

Operation 730 accesses telemetry data containing previously logged actions taken by prior users. Actions taken by prior users are identified at operation 740 from the telemetry data associated with the task. Operation 750 identifies features from the instruction content, telemetry data, derived actions, and actions taken.

Operation 760 includes inputting the feature to a machine learning model to identify a task completion path endpoint for the instructional content. The features include information based on the derived actions and actions taken associated with the task. The task completion path may include a sequence of TCIDs. In one example, the task completion path is generated by tracing a path backwards in a user interface tree from the task completion path endpoint. The instructional content may be labeled with the task completion path.

Operation 770, monitors user-initiated actions in response to access of the instructional content. Operation 775 generates an effectiveness measure for the instructional content as a function of the task completion path endpoint label and the monitored user-initiated actions to identify a portion of the instructional content for editing. Operation 780 provides the effectiveness measure to an editor for editing the instructional content.

FIG. 8 is a flowchart illustrating a computer implemented method 800 for evaluating content effectiveness. Method 800 begins at operation 810 by detecting that the instructional content has been accessed by a user. Operation 820 evaluates the user-initiated actions with respect to the task completion path to determine an effectiveness of the instructional content. Such evaluation includes determining deviations of the user-initiated actions from the task completion path at operation 830, and ranking the deviations at operation 840. The ranking may be based on drop-off points and percentages of users at each drop off-point compared to the effectiveness threshold previously described. Operation 850 provides the ranked deviations to an editor of the instructional content for use in combination with feedback from readers of the instructional content to edit the instructional content.

FIG. 9 is a block schematic diagram of a computer system 700 to automatically label instructional content and for performing methods and algorithms according to example embodiments. All components need not be used in various embodiments.

One example computing device in the form of a computer 700 may include a processing unit 702, memory 703, removable storage 710, and non-removable storage 712. Although the example computing device is illustrated and described as computer 700, the computing device may be in different forms in different embodiments. For example, the computing device may instead be a smartphone, a tablet, smartwatch, smart storage device (SSD), or other computing device including the same or similar elements as illustrated and described with regard to FIG. 7. Devices, such as smartphones, tablets, and smartwatches, are generally collectively referred to as mobile devices or user equipment.

Although the various data storage elements are illustrated as part of the computer 700, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 703 may include volatile memory 714 and non-volatile memory 708. Computer 700 may include—or have access to a computing environment that includes—a variety of computer-readable media, such as volatile memory 714 and non-volatile memory 708, removable storage 710 and non-removable storage 712. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 700 may include or have access to a computing environment that includes input interface 706, output interface 704, and a communication interface 716. Output interface 704 may include a display device, such as a touchscreen, that also may serve as an input device. The input interface 706 may include one or more of a touchscreen, touchpad, mouse, keyboard, camera, one or more device-specific buttons, one or more sensors integrated within or coupled via wired or wireless data connections to the computer 700, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 700 are connected with a system bus 720.

Computer-readable instructions stored on a computer-readable medium are executable by the processing unit 702 of the computer 700, such as a program 718. The program 718 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 718 along with the workspace manager 722 may be used to cause processing unit 702 to perform one or more methods or algorithms described herein.

### Examples

1. A computer implemented method includes accessing instructional content that describes a task for completion by a user, applying a named entity recognition natural language processing model to derive actions described in the instructional content, accessing telemetry data containing logged actions taken by users, processing the telemetry data to identify actions taken in the telemetry data associated with the task, identifying features from the instructional content, telemetry data, derived actions and actions taken, inputting the features to a machine learning model trained on training data that includes labeled instances of instructional content, telemetry data and features identified therefrom to select a task completion path endpoint label for the instructional content, monitoring user-initiated actions in response to access of the instructional content, generating an effectiveness measure for the instructional content as a function of the task completion path endpoint label and the monitored user-initiated actions to identify a portion of the instructional content for editing, and providing the effectiveness measure to an editor for editing the instructional content.
2. The method of example 1 and further including deriving a task completion path by tracing a path backwards in a user interface tree from the task completion path endpoint.
3. The method of example 2 and further including labeling the instructional content with the task completion path, detecting that the instructional content has been accessed by a user, and wherein generating the effectiveness measure comprises evaluating the user-initiated actions with respect to the task completion path to determine an effectiveness of the instructional content.
4. The method of example 3 wherein evaluating the user-initiated actions includes determining deviations of the user-initiated actions from the task completion path, and ranking the deviations.
5. The method of example 4 and further including providing the ranked deviations to an editor of the instructional content for use in combination with feedback from readers of the instructional content to edit the instructional content.
6. The method of any of examples 1-5 wherein the instructional content is a help article or tutorial and the task completion path endpoint is a last action take to complete the task.
7. The method of any of examples 1-6 wherein the actions comprise selection of user interface elements.
8. The method of example 7 wherein the user interface elements include toolbar commands having unique toolbar command IDs.
9. The method of example 8 wherein the task completion path includes a sequence of toolbar command IDs.
10. The method of any of examples 1-9 wherein identifying actions taken from the telemetry data associated with the task includes determining a time at which the instructional content was accessed, removing actions taken after a predetermined time following access, and ranking actions taken based on relevance to the instructional content to identify action taken endpoint candidates.
11. The method of example 10 wherein the predetermined time is one minute or less.
12. The method of any of examples 10-11 wherein actions described in the instructional content include instructional content endpoint candidates.
13. The method of example 12 and further including processing the action taken endpoint candidates and instructional content endpoint candidates via the machine learning model comprising a Random Forest classifier model to select the task completion path endpoint.
14. The method of example 13 wherein the Random Forest classifier model is trained on labeled training data derived from the instructional content and telemetry data based on the action taken endpoint action candidates and instructional content endpoint action candidates.
15. The method of example 14 wherein the labeled training data and input data includes multiple features selected from the group consisting of an indication identifying whether the endpoint is referenced in the instructional content, whether the endpoint is ranked in the top three most relevant candidate endpoints, whether the task endpoint is a text label, a rank of the endpoint based on the telemetry, the order in which the endpoint is referenced in the instructional content, a number of times the endpoint is referenced in the instructional content, a base frequency of the final endpoint across multiple articles, the number of times an endpoint is used upon viewing the instructional content, or a p-value for the final endpoint for the instructional content.
16. A computer implemented method includes accessing instructional content that describes a task for completion by a user. Actions described in the instructional content are derived from the instructional content. Telemetry containing logged actions taken by users is accessed and used to identify actions taken that are associated with the task. A machine learning model is used to identify a task completion path endpoint for the instructional content based on the derived actions and actions taken associated with the task.
17. The method of example 16 wherein the instructional content is a help article or tutorial and the task completion path endpoint is a last action take to complete the task.
18. The method of any of examples 16-17 wherein the actions include selection of user interface elements.
19. The method of example 18 wherein the user interface elements include toolbar commands having unique toolbar command IDs.
20. The method of example 19 wherein the task completion path includes a sequence of toolbar command IDs.
21. The method of any of examples 16-20 wherein deriving actions from instructional content is performed using a named entity recognition information extraction software.
22. The method of any of examples 16-21 wherein identifying actions taken from the telemetry data associated with the task includes determining a time at which the instructional content was accessed, removing actions taken after a predetermined time following access, and ranking actions taken based on relevance to the instructional content to identify action taken endpoint candidates.
23. The method of example 22 wherein the predetermined time is one minute or less.
24. The method of any of examples 22-23 wherein actions described in the instructional content include instructional content endpoint candidates.
25. The method of example 24 and further including processing the action taken endpoint candidates and instructional content endpoint candidates via the machine learning model comprising a Random Forest classifier model to select the task completion path endpoint.
26. The method of example 25 and further including deriving a task completion path by tracing a path backwards in a user interface tree from the task completion path endpoint.
27. The method of any of examples 25-26 and further including labeling the instructional content with the task completion path, detecting that the instructional content has been accessed for a user, monitoring user-initiated actions in response to access of the instructional content, and evaluating the user-initiated actions with respect to the task completion path to determine an effectiveness of the instructional content.
28. The method of any of examples 16-27 wherein the Random Forest classifier model is trained on labeled training data derived from the instructional content and telemetry data based on the action taken endpoint action candidates and instructional content endpoint action candidates.
29. The method of example 28 wherein the labeled training data and input data includes multiple elements selected from the group consisting of an indication identifying whether the endpoint is referenced in the instructional content, whether the endpoint is ranked in the top three most relevant candidate endpoints, whether the task endpoint is a text label, a rank of the endpoint based on the telemetry, the order in which the endpoint is referenced in the instructional content, a number of times the endpoint is referenced in the instructional content, a base frequency of the final endpoint across multiple articles, the number of times an endpoint is used upon viewing the instructional content, or a p-value for the final endpoint for the instructional content.
30. A computer implemented method includes accessing instructional content that describes a task for completion by a user, applying a named entity recognition natural language processing model to derive actions described in the instructional content, accessing telemetry data containing logged actions taken by users, processing the telemetry data to identify actions taken in the telemetry data associated with the task, identifying features from the instructional content, telemetry data, derived actions and actions taken, and providing the features to a machine learning model trained on training data that includes task completion path endpoint labeled instances of instructional content, telemetry data and features identified therefrom to select a label for the instructional content.
31. A machine-readable storage device has instructions for execution by a processor of a machine to cause the processor to perform operations to perform any of the methods of examples 1-30.
32. A device includes a processor and a memory device coupled to the processor and having a program stored thereon for execution by the processor to perform operations to perform any of the methods of examples 1-30.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
accessing instructional content that describes a task for completion by a user;
applying a named entity recognition natural language processing model to derive actions described in the instructional content;
accessing telemetry data containing logged actions taken by users;
processing the telemetry data to identify actions taken in the telemetry data associated with the task;
identifying features from the instructional content, telemetry data, derived actions and actions taken;
inputting the features to a machine learning model trained on training data that includes labeled instances of instructional content, telemetry data and features identified therefrom to select a task completion path endpoint label for the instructional content;
monitoring user-initiated actions in response to access of the instructional content;
generating an effectiveness measure for the instructional content as a function of the task completion path endpoint label and the monitored user-initiated actions to identify a portion of the instructional content for editing; and
providing the effectiveness measure to an editor for editing the instructional content.

2. The method of claim 1 and further comprising deriving a task completion path by tracing a path backwards in a user interface tree from the task completion path endpoint.

3. The method of claim 2 and further comprising:
labeling the instructional content with the task completion path;
detecting that the instructional content has been accessed by a user; and
wherein generating the effectiveness measure comprises evaluating the user-initiated actions with respect to the task completion path to determine an effectiveness of the instructional content.

4. The method of claim 3 wherein evaluating the user-initiated actions comprise:
determining deviations of the user-initiated actions from the task completion path; and
ranking the deviations.

5. The method of claim 4 and further comprising providing the ranked deviations to an editor of the instructional content for use in combination with feedback from readers of the instructional content to edit the instructional content.

6. The method of claim 1 wherein the instructional content is a help article or tutorial and the task completion path endpoint is a last action take to complete the task.

7. The method of claim 1 wherein the actions comprise selection of user interface elements.

8. The method of claim 7 wherein the user interface elements comprise toolbar commands having unique toolbar command IDs.

9. The method of claim 8 wherein the task completion path comprises a sequence of toolbar command IDs.

10. The method of claim 1 wherein identifying actions taken from the telemetry data associated with the task comprises:
determining a time at which the instructional content was accessed;
removing actions taken after a predetermined time following access; and
ranking actions taken based on relevance to the instructional content to identify action taken endpoint candidates.

11. The method of claim 10 wherein the predetermined time is one minute or less.

12. The method of claim 10 wherein actions described in the instructional content comprise instructional content endpoint candidates.

13. The method of claim 12 and further comprising processing the action taken endpoint candidates and instructional content endpoint candidates via the machine learning model comprising a Random Forest classifier model to select the task completion path endpoint.

14. The method of claim 13 wherein the Random Forest classifier model is trained on labeled training data derived from the instructional content and telemetry data based on the action taken endpoint action candidates and instructional content endpoint action candidates.

15. The method of claim 14 wherein the labeled training data and input data includes multiple features selected from the group consisting of an indication identifying whether the endpoint is referenced in the instructional content, whether the endpoint is ranked in the top three most relevant candidate endpoints, whether the task endpoint is a text label, a rank of the endpoint based on the telemetry, the order in which the endpoint is referenced in the instructional content, a number of times the endpoint is referenced in the instructional content, a base frequency of the final endpoint across multiple articles, the number of times an endpoint is used upon viewing the instructional content, or a p-value for the final endpoint for the instructional content.

16. A machine-readable storage device having instructions for execution by a processor of a machine to cause the processor to perform operations to perform a method, the operations comprising:
accessing instructional content that describes a task for completion by a user;
applying a named entity recognition natural language processing model to derive actions described in the instructional content;
accessing telemetry data containing logged actions taken by users;
processing the telemetry data to identify actions taken in the telemetry data associated with the task;
identifying features from the instructional content, telemetry data, derived actions and actions taken;
inputting the features to a machine learning model trained on training data that includes labeled instances of instructional content, telemetry data and features identified therefrom to select a task completion path endpoint label for the instructional content;
monitoring user-initiated actions in response to access of the instructional content;
generating an effectiveness measure for the instructional content as a function of the task completion path endpoint label and the monitored user-initiated actions to identify a portion of the instructional content for editing; and
providing the effectiveness measure to an editor for editing the instructional content.

17. The device of claim 16 and further comprising:
deriving a task completion path by tracing a path backwards in a user interface tree from the task completion path endpoint;
labeling the instructional content with the task completion path;
detecting that the instructional content has been accessed by a user; and
wherein generating the effectiveness measure comprises evaluating the user-initiated actions with respect to the task completion path to determine an effectiveness of the instructional content.

18. The device of claim 17 wherein evaluating the user-initiated actions comprise:
determining deviations of the user-initiated actions from the task completion path; and
ranking the deviations.

19. The device of claim 8 wherein the task completion path comprises a sequence of toolbar command IDs and wherein identifying actions taken from the telemetry data associated with the task comprises:
determining a time at which the instructional content was accessed;
removing actions taken after a predetermined time following access; and
ranking actions taken based on relevance to the instructional content to identify action taken endpoint candidates.

20. A device comprising:
a processor; and
a memory device coupled to the processor and having a program stored thereon for execution by the processor to perform operations comprising:
accessing instructional content that describes a task for completion by a user;
applying a named entity recognition natural language processing model to derive actions described in the instructional content;
accessing telemetry data containing logged actions taken by users;
processing the telemetry data to identify actions taken in the telemetry data associated with the task;
identifying features from the instructional content, telemetry data, derived actions and actions taken;
inputting the features to a machine learning model trained on training data that includes labeled instances of instructional content, telemetry data and features identified therefrom to select a task completion path endpoint label for the instructional content;
monitoring user-initiated actions in response to access of the instructional content;
generating an effectiveness measure for the instructional content as a function of the task completion path endpoint label and the monitored user-initiated actions to identify a portion of the instructional content for editing; and
providing the effectiveness measure to an editor for editing the instructional content.
